(19) United States
(12) Patent Application Publication
(10) Pub. No.: US 2010/0200500 A1
(43) Pub. Date: Aug. 12, 2010

(54) Bubble-Less Gas Delivery Into Liquid Systems

(76) Inventors: Babak Rezania, Winnipeg (CA); Jan Oleszkiewicz, Winnipeg (CA); Nazim Cicek, Winnipeg (CA)

Correspondence Address: GOWLING LAFLEUR HENDERSON LLP, P.O. BOX 30 SUITE 2300 - 550 Burrard Street, VANCOUVER - BRITISH COLUMBIA, V7X 1J1, CA

(21) Appl. No.: 12/224,411

(22) PCT Filed: Nov. 30, 2005
(86) PCT No.: PCT/CA05/01817

§ 371 Date: Apr. 13, 2010

Related U.S. Application Data
(60) Provisional application No. 60/634,602, filed on Dec. 10, 2004.

(51) Int. Cl. C02F 3/00; B01F 3/04

(52) U.S. Cl. 210/614; 210/150; 210/615

(57) ABSTRACT

A system for saturating a liquid with a gas followed by bubble-less delivery and mixing of the gas-saturated liquid into a gas-unsaturated liquid wherein a biological process is occurring. The system comprises a gas-saturation unit which controllably communicates with a bioreactor unit containing a gas-unsaturated liquid wherein a biological process is occurring. The gas saturation unit comprises a sealable pressure-resistant vessel for receiving therein an unsaturated liquid and wherein the liquid is saturated with a gas under pressure. The rate of introduction of gas-saturated liquid into the bioreactor unit is controllable to make it equivalent to the rate of gas consumption by the biological process occurring in gas-unsaturated liquid contained within the bioreactor unit. The invention is particularly useful for bubble-less gas delivery to open and closed bioreactor configurations for wastewater treatment processes.

### TECHNICAL FIELD

The present invention relates to the field of bubble-less gas delivery into liquids, and more particularly, to saturation of liquids with gases for affecting processes in liquid systems.

### BACKGROUND ART

While the invention is useful for many applications, it is directed in particular to the purification of contaminated water systems.

Nitrate contamination of water systems presents numerous significant problems and issues for governments and industries around the world because of the impacts on: (a) the availability and supply of safe drinking water, (b) ameliorating and reducing the effects of pollution on fragile ecosystems, and (c) the costs and liabilities associated with management of waste streams generated by industrial processes and urbanization. The largest source of nitrate contamination comes from intensive farming practices, primarily heavy fertilization of crops and significant animal waste production in confined spaces. Significant contamination also comes into water systems through discharges from industrial waste streams and municipal sewage plants, and also from nitrogen oxide emissions into the atmosphere from the burning of hydrocarbon fuels which are consequently incorporated into precipitation.

The most common approaches to removing nitrates from water are based on the use of microorganisms to convert nitrates into nitrogen gas through a series of steps referred to collectively as denitrification. The biological treatment of water is typically conducted and managed within contained systems commonly referred to as bioreactors. Suitable bioreactors for denitrification of water encompass in situ open-systems such as lagoons, ponds, and basins and open-top digester tanks, ex situ open-system such as open-top digester tanks, and ex situ closed-systems such as tanks and other enclosed vessels. In both types of bioreactor systems, denitrifying microorganisms may be grown in suspension in the liquid or alternatively, may be attached to solid growth support media thereby thereby forming biofilms. Two denitrification approaches are commonly used for water treatment i.e.: (a) heterotrophic denitrification wherein the microorganisms require a supplied source of organic carbon to sustain their metabolic activities, and (b) autotrophic denitrification wherein the microorganisms are able to synthesize complex organic materials from simple inorganic compounds.

Heterotrophic denitrification is a common waste water treatment strategy amenable to both open and closed-system bioreactors. Heterotrophic denitrification is very effective in nitrate removal as long as there is sufficient organic carbon available to drive the process. Consequently, it is common practice to add organic substrates such as alcohols, acetates, or waste plant debris from food processing. The advantages include high substrate loading capacities and generally rapid throughput rates. The disadvantages include the increased input treatment costs associated with the added organic carbon donor substrates, elevated sludge production and associated removal costs, organic carbon donor residuals remaining in treated water thereby contributing to unpalatable odours and tastes which require further post-denitrification treatments for clarification and deodorization of denitrified water.

Autotrophic denitrification processes utilize autotrophic microorganisms to reduce nitrates to nitrogen gas. Autotrophic microorganisms derive their energy source from inorganic oxidation-reduction reactions with elements such as hydrogen or reduced-sulfur compounds providing the requisite electron donor. They utilize inorganic carbon compounds such as carbon dioxide and carbonate as their carbon source. Consequently, autotrophic denitrification has two advantages over the heterotrophic process. First, autotrophic denitrification does not require the addition of external organic carbon sources, which significantly lowers the cost and post-treatment water problems associated with organic carbon donor residuals. Second, autotrophic denitrification produces significantly less sludge resulting in reduced costs associated with sludge removal and handling.

Development of autotrophic denitrification processes has focused on two primary electron donors, i.e., hydrogen gas or alternatively, sulfur-containing compounds. However, hydrogen gas is difficult to handle-safely and economically in large systems due to its low solubility which results not only in low mass transfer rates into microbial processes, but also rapidly dissipates into headspaces above the liquid systems thereby causing potential explosion hazards. Consequently, more efforts have been placed on developing systems and equipment for the use of sulfur-reducing microorganisms for autotrophic denitrification in closed-system bioreactors.

Sulfur-based autotrophic denitrification systems may use elemental sulfur or alternatively, thiosulfate compounds as the electron donor. The sulfur containing compounds are delivered in a slurried format to the denitrification systems. Such systems include fixed-bed bioreactors wherein the inorganic carbon sources are provided as granulated limestone, or as larger rock material exemplified by lava rocks. In such systems, the microorganisms will form biofilms on the surfaces of the granular substrates. Alternatively, sulfur-reducing microorganisms may be kept in suspension by their use in bioreactors such as fluidized bed digesters and continuous stirred tank reactors under aerobic or anaerobic conditions wherein sulfur compounds are slurried. In these systems, inorganic carbon may be supplied as pulverized limestone or alternatively, as carbon dioxide gas. Disadvantages associated with elemental sulfur-based autotrophic denitrification using suspended microbial cultures, include poor mixing and distribution of sulfur throughout liquid substrates in closed-system bioreactors due to elemental sulfur's low specific gravity, poor microbial culture development and denitrification performance when influents contain relatively low nitrate concentrations, a tendency to build-up concentrations of nitrites and sulfates when influents contain higher nitrate concentrations to levels whereby feedback inhibition of the denitrification process occurs thus limiting its efficiency. Disadvantages associated with sulfur-reducing autotrophic denitrification systems wherein the inorganic carbon is supplied in solid forms include the inability to maintain constant high rates of denitrification over extended periods of time as the biofilms grow thicker and more dense around the solid inorganic carbon sources. Therefore, costly scouring methods and equipment must be employed to dislodge and manage biofilm development and performance. A further disadvantage with all sulfur-based autotrophic denitrification systems is the production of malodorous hydrogen disulfide gas that must be collected and reconverted into reusable forms of sulphate.

Therefore, despite the disadvantages associated with the use of hydrogen gas for autotrophic denitrification, the use of hydrogen as an energy source for autohydrogenotrophic microorganisms provides a commercially feasible and economic alternative for denitrification of water systems. Advantages of hydrogen-driven denitrification include lower unit cost of electron donor, and minimal concentration of residual donor.

With developing membrane technology, the bubble-less dissolution of hydrogen into the water was made possible by using micro-porous membrane diffusers. These membranes have been used to introduce the hydrogen to biofilms and to suspended autohydrogenotrophic bacteria to drive denitrification. However, although these membranes show very high hydrogen transfer rates during start-up stages, there are numerous impediments that currently limit the applications for membrane-based hydrogen delivery in long-term denitrification installations. The main limitations include:
1. The membranes are very fragile and any physical damage to the membrane causes bubble formation and ineffective hydrogen delivery.
2. In cases where membrane diffusers are in direct contact with biological medium, their mass transfer efficiency decreases.
3. Biofilms grown on membrane surfaces are usually thick thereby reducing the efficiency of hydrogen uptake as the biofilm expands. Furthermore, scouring or sheering biofilms from the membrane surfaces is difficult due to precipitation of inorganic compounds inside the biofilm mass.
4. The hydrophobicity of the membranes change over time due to condensation of water vapour inside the biofilm. The changes in hydrophobicity of the membranes make them vulnerable to irreversible fouling.

### SUMMARY OF THE INVENTION

The exemplary embodiments of the present invention, at least in preferred forms, are directed to equipment, systems and methods for saturating liquids with gases to concentrations significantly greater than the solubilities of the gases in those liquids under ambient conditions, and then delivery of the gas-saturated liquids into vessels or the like where the dissolved gas is to be consumed, e.g. bioreactors to affect biological processes therein.

The inventors of the present invention have found that when a liquid containing a gas dissolved therein under pressure i.e. the liquid is supersaturated with the gas, is fed to a vessel which is operating at a lower pressure in which the gas is utilized or consumed, gas bubbles will form only when the liquid in the vessel has been saturated with the gas at the prevailing pressure. When the gas-supersaturated liquid is released to a vessel containing liquid that is not saturated with the gas, the gas from the gas-saturated liquid introduced into the vessel first commingles with and saturates the liquid in the vessel and only then forms initially microbubbles not visible to the naked eye followed by formation of larger bubbles. If delivery of the dissolved gas is less than or equal to the uptake or consumption of the gas in the vessel (e.g. consumption in a biological process), substantially no bubbles will be formed in the vessel. The appropriate delivery rate can be determined from a knowledge of or observation of rates of utilization or consumption of the gas in the vessel, which allows appropriate rates to be established for dissolving the gas and delivering the resulting gas-saturated liquid solution to the vessel.

It should be realized that the term “vessel” as used herein should be given a broad interpretation to include not only open or closed containers or tanks, but such other liquid reservoirs as ponds, lagoons or flowing bodies of liquid such as streams.

According to a preferred embodiment of the present invention, there is provided a closed-system gas-saturation apparatus having a saturation tank, a liquid inflow line, a liquid feed pump connected into the liquid inflow line for pumping and precisely regulating the flow of liquids therethrough into the saturation tank, a gas supply line, a gas supply valve for controlling the flow of gas into the saturation tank, a liquid outflow line, a pressure regulator valve interconnected into the liquid outflow line for precisely controlling the flow of liquid therethrough out of the saturation tank, a microprocessor, a pressure sensor communicable with the microprocessor, and a dissolved gas sensor communicable with the microprocessor. The saturation tank may optionally be fitted with a mixing apparatus for commingling liquids and gases introduced into the saturation tank, one or more drainage valves for removal of liquids from the saturation tank, one or more pressure relief valves for releasing gases from the saturation tank's headspace, instrumentation for monitoring and displaying selected physical and chemical parameters within the saturation tank, and controlling devices communicable with the microprocessor for electronically affecting operation of the inflow liquid pump, gas supply valve, outflow pressure regulator valve, and pressure relief valve. The liquid inflow line may optionally be fitted with a spray nozzle attachment at its terminus into the saturation tank for dispersing a liquid flow into a spray upon entry into the saturation tank. It is preferable that the instrumentation and controlling devices are interconnected with, communicable with and controllable by the microprocessor. Operation of the saturation unit commences by pumping a liquid into the saturation tank while the outflow pressure regulator valve is in an open position, until a selected volume is reached under ambient conditions. The outflow pressure regulator valve is then closed and a selected gas is introduced into the saturation tank under pressure and commingled with the liquid. As the pressure within the tank increases with addition of gas, the gas molecules will be prevented from bubbling through the liquid to the headspace interface and dispersing into the saturation tank's headspace, but instead, will increasingly commingle with and integrate into the liquid molecules thereby saturating the liquid with solubilized gas. The degree of saturation of the liquid with the gas can be precisely controlled and adjusted to desired levels by monitoring the process with sensing devices concurrent with electronic manipulation of the inflow liquid pump and gas supply, and optionally with a pressure relief valve if so fitted. The saturated liquid may then be precisely and controllably delivered from the saturation tank by microprocessor-controlled operation of the liquid feed pump in cooperation with the pressure regulator valve.

According to a preferred aspect of the present invention, there is provided a system for the generation, delivery and use in a biological process of liquids saturated with a selected gas, made up of a closed-system gas-saturation unit connected to and communicating with a bioreactor, supplies of a selected liquid and a selected gas to the saturation unit, supplies of one or more of liquid, gaseous and solid feed stocks to the bioreactor, and controllable devices for the release/removal of solid, liquid and gaseous products and by-products from the bioreactor. The solid, liquid and gaseous products and by-products released/removed from the bioreactor may be optionally released into ecosystems such as waterways, onto terrain, or into the atmosphere, or alternatively, collected into closed-systems for further processing for use in other industrial uses. Such processing and industrial uses may optionally include recycling the products and by-products back into the saturation unit and/or the bioreactor to further drive the biological processes occurring within the bioreactor. This system is adaptable for use with a variety of bioreactors including ex situ closed-system bioreactors. Furthermore, this system may also be used in situ groundwater denitrification by injecting supersaturated hydrogen into groundwater wherein microorganisms are cultivated in a controlled manner and materials are converted or transformed via specific metabolically mediated reactions commonly referred as bioprocesses. Such ex situ closed-system bioreactors are exemplified by continuous stirred-tank reactors, continuous flow stirred-tank reactors, plug-flow reactors, and fluidized-bed reactors wherein parameters such as the compositions and inflow rates of nutrients and feed stocks, temperature, pressure, pH, agitation of the liquid phase, and rates of removal of products and by-products are precisely controlled by instrumented monitoring electronically connected to and communicating with a microprocessor configured to controllably affect the operation of the inflow, outflow, agitation and circulation control devices. Microbial growth in such bioreactors may be suspended in the liquid phase, or alternatively, managed and controlled to form biofilms on surfaces of physical supports. If so desired, solid support systems may be added to the working volumes of the bioreactors to facilitate the development of biofilms, and optionally as exemplified by micro-porous hollow-fibre membrane filters, to provide means for separating metabolic products and/or by-products from the bioreactor feed stocks. Alternatively, the system provided by this embodiment is adaptable for use with in situ open-system bioreactors commonly employed for open-system treatment of industrial waste water, municipal waste and sewage, and contaminated ground water and exemplified by ponds, lagoons and open-top tanks and digesters. Furthermore, the system provided by this embodiment is amenable for both aerobic and anaerobic microbial processes occurring with bioreactors. It should be noted that regardless of the type of bioreactor employed in this system, if so desired, the liquid supply to the saturation unit may be drawn from the same source as the feed stock supply to the bioreactor.

According to another preferred aspect of the present invention, there is provided a method for controllably saturating liquids with selected gases for delivery to bioreactors. The method provides a closed-system gas-saturation unit consisting of a saturation tank, a liquid inflow line, a liquid pump connected into the liquid inflow line for pumping and precisely regulating the flow of liquids therethrough into the saturation tank, a gas supply line, a gas supply valve, a liquid outflow line, a pressure regulator valve interconnected into the liquid outflow line for precisely controlling the flow of liquid therethrough out of the saturation tank, a microprocessor, a pressure sensor communicable with the microprocessor, and a dissolved gas sensor communicable with the microprocessor. The saturation tank may optionally be fitted with mixing apparatus for commingling liquids and gases introduced into the saturation tank, drainage valves for removal of liquids, pressure relief valves for releasing gases from the headspace, instrumentation communicable with the microprocessor for monitoring and displaying selected physical and chemical parameters within the saturation tank, and controlling devices are interconnected with, communicable with and controllable by the microprocessor for electronically affecting operation of the inflow liquid pump, gas supply valve, and the outflow pressure regulator valve. A selected liquid is pumped into the saturation tank while the outflow pressure regulator valve is in an open position, until a selected volume is reached under ambient conditions. The outflow pressure regulator valve is then closed and a selected gas is introduced into the saturation tank under pressure and commingled with and integrated into the liquid. After the selected degree of saturation is reached, the saturated liquid may be delivered from the saturation unit by controllably opening the outflow pressure regulator valve. If so desired, a constant supply of saturated liquid may be delivered over extended periods from the saturation unit by co-adjusting the outflow regulator valve in communication with the controls for the gas supply and inflow liquid pump whereby constant feeds of inflow liquid and gas are supplied in communication with the outflow delivery of saturated liquid. As illustration of how this method may be practised, under ambient atmospheric pressure and a temperature of 20° C., the maximum solubility of hydrogen gas in water is about 1.62 mg/L. Addition of hydrogen gas into water contained in an open-system will result in hydrogen gas bubbles formed within the matrix of water molecules wherein the gas bubbles will turbulently rise to the water surface and dissipate into the atmosphere. However, when hydrogen gas is introduced into the closed-system saturation unit with the pressure regulator valve closed and filled with water to a selected level, the hydrogen molecules will be increasingly integrated into the water molecules as increasing amounts of hydrogen gas are introduced under pressure into saturation tank. It is possible with this method to attain concentrations of dissolved hydrogen on the order of 16.2 mg/L and greater if so desired. It is possible to provide a constant supply by controllably adjusting the flow rate of gas-saturated liquid through the liquid outflow line in co-reference to the rate of gas supply and the flow rate of liquid through the liquid inflow line.

According to a further preferred aspect of the present invention, there is provided a method for supplying a flow of gas-saturated liquid to a bioreactor at a rate controllably adjusted to the rate of biological consumption of the gas within the bioreactor, thereby avoiding loss of gas from the saturated liquid in form of bubbles dissipating into the bioreactor head space. The saturation tank is equipped with sensing devices and instrumentation for repeated or optionally, continual measurements and monitoring of the concentration of one or more solubilized gases in the liquid added to and contained within the saturation tank. The gas monitoring equipment is electronically communicable with a microprocessor configured to communicate with and control the liquid feed pump, gas supply valve and/or the pressure regulator valve. The bioreactor is equipped with sensing devices and instrumentation in communication with the microprocessor for repeated or optionally, continual measurements and monitoring of the concentration of one or more solubilized gases in a liquid system contained within the bioreactor. The bioreactor gas monitoring equipment is also electronically communicable with a microprocessor configured to communicate with and control the liquid feed pump whereby the rate of flow of gas-saturated liquid through the outflow pressure regulator valve is modulated in response to electronic signals received from the bioreactor and the gas-saturation tank.

According to another preferred embodiment of the present invention, there is provided a system for saturating a liquid with a gas and delivery of the gas-saturated liquid to a biological process, wherein the system comprises: (a) a closed-system gas-saturation unit comprising a sealable vessel for saturating an unsaturated liquid therein with a gas thereby producing a gas-saturated liquid, a liquid feed supply line having a pump interconnected therein for pumping the unsaturated liquid into the vessel, a gas supply for delivering the gas into the vessel, and a gas-saturated liquid outflow line having a communicatingly controllable pressure regulator valve interconnected therein, (b) a bioreactor unit for containing a biological process therein, the bioreactor unit connected to the gas-saturated liquid outflow line of the closed-system gas-saturation unit and communicating therewith the pressure regulator valve, and (c) a control means for controlling release of gas-saturated liquid from the closed-system gas-saturation unit through the pressure regulator valve into the bioreactor unit.

According to yet another preferred embodiment of the present invention, there is provided a system for saturating a liquid with a gas whereafter the gas-saturated liquid is delivered to a liquid system thereby affecting the liquid system, the system comprising: (a) a closed-system gas-saturation unit comprising a sealable vessel for saturating an unsaturated liquid therein with a gas thereby producing a gas-saturated liquid, a liquid feed supply line having a pump interconnected therein for pumping the selected unsaturated liquid into the vessel, a gas supply for delivering the selected gas into the vessel, and a gas-saturated liquid outflow line having a communicatingly controllable pressure regulator valve interconnected therein, and (b) a reactor unit for containing a liquid system therein, the reactor unit connected to the gas-saturated liquid outflow line of the closed-system gas-saturation unit and communicating therewith the pressure regulator valve.

According to a further preferred embodiment of the present invention, there is provided a method for affecting a biological process within a bioreactor, the method comprising: (a) saturating an unsaturated liquid with a gas with a pressure applied in a closed-system gas-saturation unit thereby producing a gas-saturated liquid, and (b) controllably delivering the gas-saturated liquid to a bioreactor receiving a liquid supply therein, the bioreactor containing a biological process therein.

According to a further preferred embodiment of the present invention, there is provided a method for denitrification of a nitrate-containing water supply, the method comprising: (a) saturating an unsaturated liquid with a gas with a pressure applied in a closed-system gas-saturation unit thereby producing a gas-saturated liquid, and (b) controllably delivering the gas-saturated liquid to a bioreactor receiving a supply of nitrate-containing water and containing a biological denitrification process therein.

### BRIEF DESCRIPTION OF THE DRAWINGS

The present invention will be described in conjunction with reference to the following drawing in which:

FIG. 1 is a schematic view of one embodiment of the present invention;

FIG. 2 is a graph showing dissolved hydrogen concentrations in water circulating through the embodiment shown in FIG. 1—Stage A shows results when there is no mixing in the separator and no membrane scouring; Stage B shows the saturator mixer on and no membrane scouring; Stage C shows the separator mixer off and membrane scouring on (30 L/min);

FIG. 3 is a graph showing the denitrifying performance of the embodiment shown in FIG. 1 and is a comparison of nitrate levels in the influent and effluent during treatment of synthetic waste water,

FIG. 4 is a graph showing the concentrations of volatile suspended solids (VSS) and total suspended solids (TSS) produced during treatment of synthetic waste water with the embodiment shown in FIG. 1;

FIG. 5 is a graph showing concentrations of soluble organic carbon (COD) produced during treatment of synthetic waste water with the embodiment shown in FIG. 1;

FIGS. 6a and 6b are graphs showing flux and pressure through, respectively, first and second membrane filter units during treatment of synthetic waste water with the embodiment shown in FIG. 1;

FIG. 7 is another graph showing the denitrifying performance of the embodiment shown in FIG. 1 and is specifically a comparison on nitrate levels in influent and effluent samples collected during treatment of municipal final effluent;

FIG. 8 is a graph showing the concentrations of volatile suspended solids (VSS) and total suspended solids (TSS) produced during treatment of municipal final effluent with the embodiment shown in FIG. 1; and

FIG. 9 is a graph showing concentrations of soluble organic carbon (COD) produced during treatment of municipal final effluent with the embodiment shown in FIG. 1.

### BEST MODES FOR CARRYING OUT THE INVENTION

Embodiments of the present invention provide equipment, systems and methods for saturating liquids with gases to concentrations significantly greater than the gases' solubility in those liquids under ambient conditions, and then delivery of the gas-saturated liquids into vessels where the dissolved gas is to be consumed. If the rate of delivery of the gas/liquid solution to the vessel is less than or equal to the rate at which the gas is consumed or utilized in the vessel, gas bubbles do not form in the vessel. In the following, the vessels are exemplified as bioreactors, and the gases are intended to affect biological processes therein.

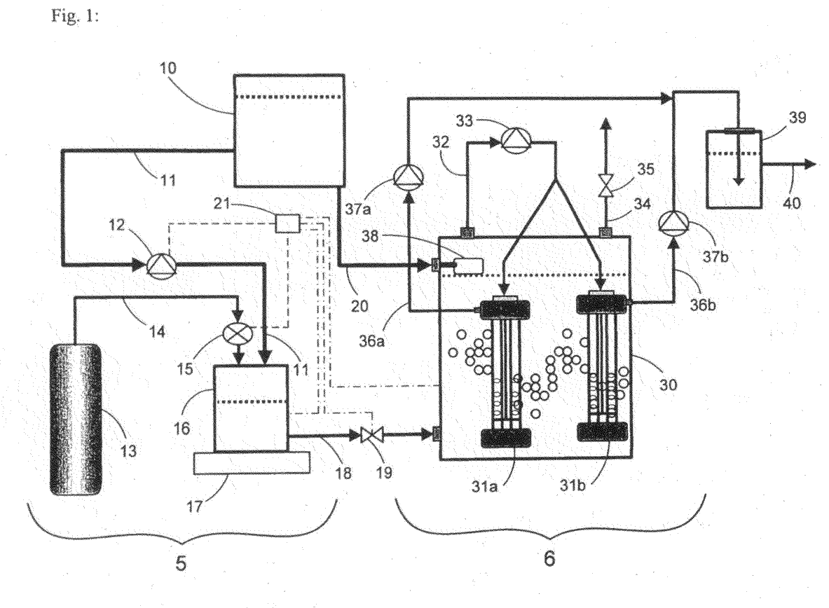

A specific embodiment of the water purification system of the present invention is illustrated in FIG. 1 and comprises two separate units: a gas-saturation unit 5 and a bioreactor unit 6, both units receiving a liquid feed from a liquid feed storage tank 10. The gas-saturation unit 5 comprises a gas-saturation mixing tank 16 having a total volume of 8.5 litres (L), and is connected to a liquid inflow line 11 and liquid outflow line 18. An electronically controllable liquid feed pump 12 is interconnected to liquid inflow line 11, and a pressure regulator valve 19 is interconnected with liquid outflow line 18. A selected gas is controllably supplied through an electronically controllable gas valve 15 to the gas-saturation mixing tank 16 through a gas supply line 14 connected to a cylinder 13 which in this example contains hydrogen gas. The gas-saturation mixing tank 16 is also provided with a pressure sensor (not shown) electronically communicable with a microprocessor 21 and a dissolved gas sensor (not shown) electronically communicable with the microprocessor 21, the microprocessor 21 being programmed or configured for cooperating with the sensors, the liquid feed pump 12 and the gas valve 15 for precisely controlling the pressure within the gas-saturation mixing tank 16 and the degree of gas-saturation provided to the liquid contained therein, as well as the rate of feed of the gas-saturated liquid through the pressure regulator valve 19 to the bioreactor 6. The gas saturation unit 5 is optionally provided with an agitator 17 to agitate the liquid feed in mixing tank 16 while it is being saturated with gas. The gas-saturated liquid is controllably released from the gas-saturation mixing tank 16 by outflow pressure regulator valve 19.

The bioreactor unit 6 in this example is a closed-system reactor comprising a cylindrical vessel 30 made of a light transparent weather-resistant thermoplastic material (e.g. Plexiglas®) having a total volume of 10.1 L with a working volume of 5.6 L, into which are fitted two hollow-fibre membrane filter units 31a and 31b (Model ZW-1 manufactured by Zenon Environmental Inc., 3239 Dundas Street West, Oakville, Ontario, Canada L6M 4B2) each having a nominal pore size of 0.04 μm and, a combined total surface area of 0.094 m². The bioreactor unit 6 is connected to a bioreactor feed supply line 20 and to a headspace pressure relief line 34 to which is fitted a pressure regulator valve 35. Liquid outflow line 18 from the gas-saturation unit 5 is connected to the cylindrical vessel 30. The hollow-fibre membrane filter units 31a and 31b are connected to permeate outflow lines 36a and 36b into which permeate pumps 37a and 37b are interconnected. A headspace gas recirculation line 32 is fitted into the cylindrical vessel 30 and is interconnected with gas recirculation pump 33 for recirculating the headspace contents of bioreactor unit 6 into the hollow-fibre membrane filter units 31a and 31b for providing from time to time in response to excessive formation of biofilms, a scouring action to remove portions of biofilms forming on the outer surfaces of the hollow-fibre membrane filter units 31a and 31b. It is preferred that the gas recirculation pump 33, pressure regulator valve 35, and permeate pumps 37a and 37b are communicable with the microprocessor 21 to enable electronic control of the scouring action.

A portion of the liquid feed, which in this example would be a wastewater, is pumped from the liquid feed storage tank 10 to the gas-saturation mixing tank 16 through the liquid inflow line 11 by the liquid feed pump 12 concurrent with a supply of hydrogen gas through gas supply valve 15 interconnected with gas supply line 14 from cylinder 13, thereby causing pressure to build-up in the gas-saturation mixing tank 16 and subsequently forcing the hydrogen gas molecules to become increasingly integrated into water molecules thereby saturating the water molecules with hydrogen gas. The liquid feed is preferably agitated during the gas saturation process. When pressure within the gas saturation mixing tank 16 reaches a preset level, the outflow pressure regulator valve 19 controllably releases the hydrogen-saturated wastewater through the liquid outflow line 18 into the bioreactor unit 6. Bubble-less hydrogen gas delivery is achieved by delivering the hydrogen-saturated liquid feed to the bioreactor unit 6 at rates approximately equal to the rates of hydrogen uptake and metabolism by biological processes ongoing within the bioreactor unit 6. Pressure and dissolved gas sensors (not shown) communicable with the microprocessor 21 are provided within the bioreactor vessel 30 to provide electronic feedback to the microprocessor 21 to enable precise electronic control for the operation of the liquid feed pump 12 thereby ensuring that the delivery of the gas-saturated liquid through the outflow pressure regulator valve 19 interconnected with outflow line 18 does not exceed the rate of utilization of the hydrogen by the biological processes occurring in the bioreactor unit 6 under normal operating conditions.

Supplying hydrogen and nitrate (already present in the waste water) to the bioreactor unit 6 provides conditions favourable for hydrogenotrophic denitrifying microoganisms to proliferate within the wastewater liquid feed delivered to bioreactor vessel 30 from storage tank 10. Hydrogenotrophic denitrifiers metabolise hydrogen and nitrate present in the wastewater resulting in the conversion of nitrates to nitrogen gas. The biomass produced in bioreactor unit 6 is separated from the treated wastewater by the hollow-fibre membrane filter units 31a and 31b. The headspace in cylindrical vessel 30 is filled with nitrogen gas produced during denitrification, and is recycled through gas recirculation line 32 by gas recirculation pump 33 for mixing with wastewater contained within the vessel 30 and for membrane scouring. Excess nitrogen gas is released automatically to the atmosphere through pressure relief line 34 through the operation of pressure relief valve 35. Eventually, the bioreactor is taken off-line and cleaned to remove solids that build up during the process.

### Example 1

An experiment using the preferred embodiment of the present invention illustrated in FIG. 1 was conducted to assess the mass transfer of hydrogen gas from supersaturated water released from the saturation mixing tank 16 into unsaturated water contained within the bioreactor unit 6. Pure water contained in storage tank 10 was pumped into the bioreactor vessel 30 after which, the headspace in the bioreactor vessel 30 was filled with nitrogen gas. Hydrogen gas was released from the gas cylinder 13 into the gas saturation mixing tank 16 until a pressure of 120 psi was reached. Then, water was pumped from the storage tank 10 into the gas saturation mixing tank 16 at a flow rate of 37 mL/min and was continuously mixed by agitator 17. The working pressure of outflow regulator valve 19 interconnected with liquid outflow line 18 was adjusted to 125 psi thereby maintaining pressure within the gas saturation mixing chamber at 125 psi. Hydrogen-saturated water was then controllably introduced to bioreactor unit 6 by the outflow pressure regulator valve 19 through the liquid outflow line 18. At steady-state conditions, the flow rate of the liquid feed pump 12 transferring water from the storage tank 10 into the gas saturation mixing tank 16 was equal to the flow rate of the hydrogen-saturated water released by outflow pressure regulator valve 19 from the mixing tank 16 into the bioreactor vessel 30. The volume of water maintained in the bioreactor vessel 30 was kept constant with a float valve 38, which controlled flow of water from the storage tank 10 into bioreactor vessel 30. Hydrogen-saturated water from the gas-saturation mixing tank 16 and unsaturated water from the storage tank 10 were commingled, mixed and circulated in the bioreactor vessel 30, while the headspace in the bioreactor vessel 30 was filled and maintained with nitrogen gas. Permeate emanating from the bioreactor vessel 30 through hollow-fibre membrane filter units 31a and 31b was pumped out of the bioreactor unit 6 by permeate pumps 37a and 37b at a flow rate of 480 ml/min. The membrane filter units 31a and 31b were periodically scoured by reversing the permeate pumps 37a and 37b thereby forcing permeate back through the membrane filter units 31a and 31b into the bioreactor vessel 30. The dissolved hydrogen concentration of the commingled water circulating in the bioreactor vessel 30 was monitored using an online dissolved hydrogen analyzer in a closed-system (not shown). Dissolved hydrogen gas levels in supersaturated water circulating in the gas saturation mixing tank 16 was measured by the headspace method described by Schmidt et al. in Applied and Environmental Microbiology Vol. 59 pages 2546-2551 (1993). Measurements were taken during three stages of the study: (1) Stage A during which time water in the gas saturation mixing tank 16 was not mixed and no membrane scouring was applied, (2) Stage B during which time water in the gas saturation tank was agitated but no membrane scouring was applied, and (3) Stage C during which time the water in the gas saturation mixing tank was not agitated, but membrane scouring was applied.

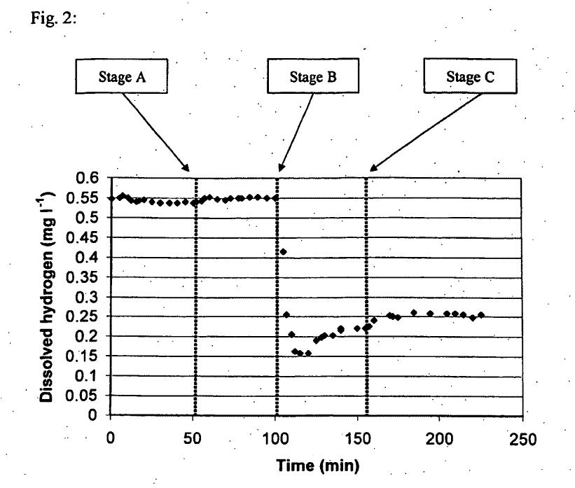

FIG. 2 shows that the dissolved hydrogen concentration in commingled water circulating in the bioreactor vessel 30 was maintained at steady-state conditions. In the first part of the experiment i.e. Stage A, the agitator 17 was shut off thereby not mixing water contained in gas saturation mixing tank 16 with the hydrogen gas present in the headspace of tank 16. During this stage, the dissolved hydrogen content in the bioreactor vessel was approximately 0.55 mg/L. In order to calculate the mass transfer efficiency, the dissolved hydrogen concentration in the gas saturation mixing tank 16 was measured by taking samples from pressure regulator valve 18 and was recorded as 7.18 mg/L. Hydrogen mass balance calculations confirmed that 100% hydrogen delivery was achieved. During the second part of the experiment i.e. Stage B, agitation of water in the gas saturation mixing unit 16 did not affect its dissolved hydrogen contents. This was due to a short retention time in the gas saturation mixing tank 16 thereby resulting in only small mixing effects. During the third part of the experiment i.e. Stage C, the headspace gases in the bioreactor vessel 30 were circulated through the hollow-fibre membrane filter units 31a and 31b at a rate of 30 L/min. The dissolved hydrogen content in the bioreactor vessel 30 decreased from 0.55 mg/L to 0.2 mg/L indicating that the circulating headspace gases stripped out some portion of the dissolved hydrogen gas from headspace within the bioreactor vessel 30. In the last step of the experiment i.e. the later part of Stage C, decreasing the flow rate of water re-circulating through the bioreactor vessel 30 from 30 L/min to 15 L/min increased the dissolved hydrogen concentration from 0.2 to 0.25 mg/L.

### Example 2

An experiment using the preferred embodiment of the present invention illustrated in FIG. 1 was used to assess denitrification of a high-nitrate synthetic wastewater. The synthetic wastewater was prepared by dissolving 25 mg L⁻¹ NO₃—N, 1000 mg L⁻¹ NaHCO₃, 25 mg L^{-1 KH}₂PO₄, 5 mg L⁻¹ CaCl₂, 25 mg MgSO₄.7H₂O and 1 mg L^{-1 FeSO}₄ in pure water. The storage tank 10 and the bioreactor vessel 30 were filled with the synthetic wastewater while the gas saturation mixing tank 16 was filled with hydrogen gas from gas cylinder 13 until the pressure inside tank 16 was 120 psi. The synthetic wastewater transferred into the bioreactor vessel 30 was then inoculated with wastewater-activated sludge containing hydrogenotrophic denitrifying bacteria. The wastewater-activated sludge was obtained from a municipal water treatment facility located in Winnipeg, Manitoba, Canada. The working pressure of the outflow pressure regulator valve 19 interconnected to the liquid outflow line 18 was adjusted to 125 psi thereby maintaining pressure within the gas-saturation mixing chamber 16 at 125 psi. The synthetic wastewater was then pumped from the storage tank 10 into the gas-saturation mixing tank 16 wherein it was mixed by agitator 17. After the synthetic wastewater was supersaturated with hydrogen gas as determined by the head space method described in Example 2, it was then released from the gas saturation mixing tank 16 through the saturated feed outflow line 18 by the outflow pressure regulator valve 19 into the bioreactor vessel 30 wherein the supersaturated synthetic wastewater was commingled and mixed with the unsaturated synthetic wastewater which had been previously inoculated with wastewater-activated sludge containing hydrogenotrophic denitrifying bacteria. Concurrent with the introduction of the supersaturated synthetic wastewater into the bioreactor vessel 30, the flow rate of synthetic wastewater from the storage tank 10 into the bioreactor vessel 30 was set at 17 mL min⁻¹ while the flow rate of synthetic wastewater from the storage tank 10 into the gas saturation mixing tank 16 was set at 16 mL min⁻¹ and was maintained at this rate for the duration of the study. A constant volume of wastewater was maintained in the bioreactor vessel 30 by the float valve 38 which regulated the flow of synthetic wastewater from the storage tank 10. The delivery of high concentrations of hydrogen and nitrate into the bioreactor vessel 10 stimulated metabolism and proliferation by the hydrogenotrophic denitrifying bacteria thereby converting nitrate into nitrogen gas which accumulated in the headspace of the bioreactor vessel 30 from where it was periodically recycled through gas recirculation line 32 into the hollow-fibre membrane filter units 31a and 31b by the gas recirculation pump 33. The recycled nitrogen gas was forced from the interior to the exterior of the hollow-fibre membrane filter units 31a and 31b thereby: (a) scouring from the outer surfaces of the filters any biofilms that may have been formed there by the hydrogenotrophic denitrifying bacteria, and (b) facilitating the mixing and turbulence of the synthetic wastewater contained within the bioreactor vessel 30. When the headspace gases were not being recycled through the membrane filter units 31 a and 31b, denitrified water diffused from the bioreactor vessel 30 through the membrane filter units 31a and 31b thereby separating the denitrifying bacteria from the treated water which is also referred to as permeate. The permeate was removed from the bioreactor vessel 30 through permeate outflow lines 36a and 36b by permeate pumps 37a and 37b into a permeate holding tank 39 and then released through effluent outflow line 40. The venting of excess nitrogen gas formed in the headspace of the bioreactor vessel 30 was controlled through the pressure relief line 34 by the pressure regulator valve 35.

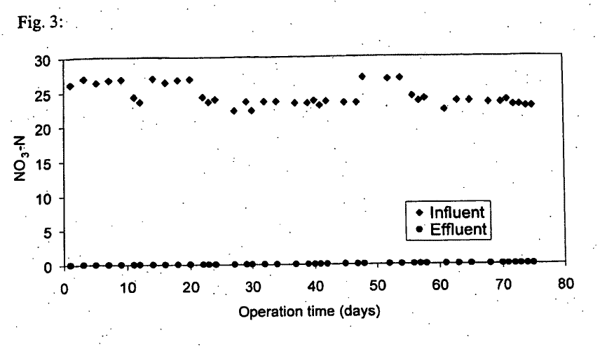

FIG. 3 shows that the water purification treatment system of the present invention was effective in complete removal of nitrates from the synthetic wastewater feed. The synthetic wastewater influent coming from the storage tank 10 was 25 mg L⁻¹ NO₃—N with a loading rate of 0.11 kg N m⁻³ d⁻¹. However, NO₃—N was not detected in effluent samples collected from the permeate holding tank 39 throughout the 75-day duration of the study. Furthermore, no nitrite accumulation was observed. The dissolved hydrogen concentrations in the effluent samples ranged between 0.05 to 0.1 mg L⁻¹.

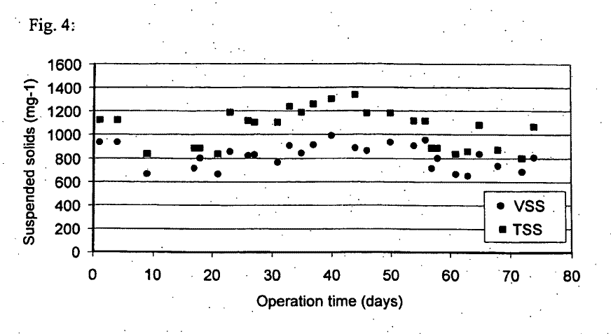

FIG. 4 shows the concentrations of volatile suspended solids (VSS) and total suspended solids (TSS) measured during the 75-day duration of the study. The average value for the VSS component was 803±108 mg l⁻¹ and the average value for the TSS component was 1033±166 mg l⁻¹. Based on a solids retention time of 20 days, the calculated yield of VSS in this system was 0.36 mg per mg N removed. The inorganic fraction of TSS was attributed to the precipitation of Ca²⁺ with phosphate and/or carbonate ions, thereby creating calcium-phosphate or calcium-carbonate solids. Cations such as Ca²⁺ and Mg²⁺ normally present in water can precipitate basic anions, such as hydroxide, carbonate, phosphate, mono-hydrogen phosphate and di-hydrogen phosphate. Minerals with higher pK_{S0}, such as Ca₅ (PO₄)₃OH, Ca₃ (PO₄)₂ and CaCO₃ have lower solubilities, and therefore are expected to be the major contributors to the inorganic fraction of TSS. It should be noted that solubility of precipitated materials is pH dependent as higher precipitation of inorganic compounds is expected at higher pHs.

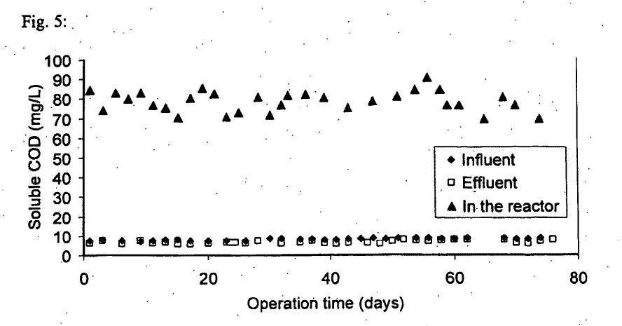

FIG. 5 shows that the concentrations of soluble organic carbon (COD) in both the influent and the effluent streams of synthetic wastewater were nearly identical during the course of this study. The data indicate that the influent contained some COD. It is likely that the tap water used to prepare the synthetic wastewater contained small quantities of natural organic matter and/or disinfection by-products produced during chlorination of municipal tap water. The COD present in the effluent may have originated from soluble microbial products (SMP) produced during denitrification or alternatively, may have been the result of organic carbon carryover from the synthetic wastewater feed. A simple test was conducted to test if the organic carbon in the feed was possibly rejected by the membrane. The test results showed that almost all of the soluble organic carbon in the feed passed through the membrane filter units 31a and 31b.

During autotrophic denitrification processes, generation of organic carbon occurs due to release of SMP. SMP are considered to contain utilization-associated products (UAP) and biomass-associated products (BAP). UAP are associated with substrate metabolism and biomass growth and are produced at rates proportional to substrate utilization, which in this study, was the denitrification rate. BAP are associated with biomass decay and are produced at rates proportional to biomass concentrations. In order to assess the fate of organic carbon, the biodegradability kinetics of organic carbon is required. The degradation of organic carbon requires heterotrophic activity. Despite the autotrophic condition in the reactor, the degradation of SMP in the reactor is possible. It has been found that all of hydrogen-dependent denitrifies are mixotrophic as they are able to use inorganic carbon under autotrophic and organic carbon under heterotrophic conditions. SMP are slowly biodegradable and the kinetics of their degradation under aerobic conditions are well understood. However, SMP have high saturation coefficients and low utilization rates and therefore, SMP require long hydraulic retention times for significant biodegradation to occur. Furthermore, when the nitrates serve as the electron acceptors, the rates of degradation are further reduced. The assumption was made in the study that SMP degradation would not occur to a significant extent during the three-hour hydraulic retention time. To confirm the assumption, the waste biomass from the reactor vessel 30 was transferred to a batch reactor system and spiked with supplemental nitrate. Nitrogen gas was bubbled into the batch reactor system to provide anoxic conditions. Because the SMP was the only electron donor, the rate of nitrate consumption would provide evidence of biodegradation of SMP. However, only a small amount of nitrate was consumed during the 3-hour test period thereby showing the assumption made above was valid.

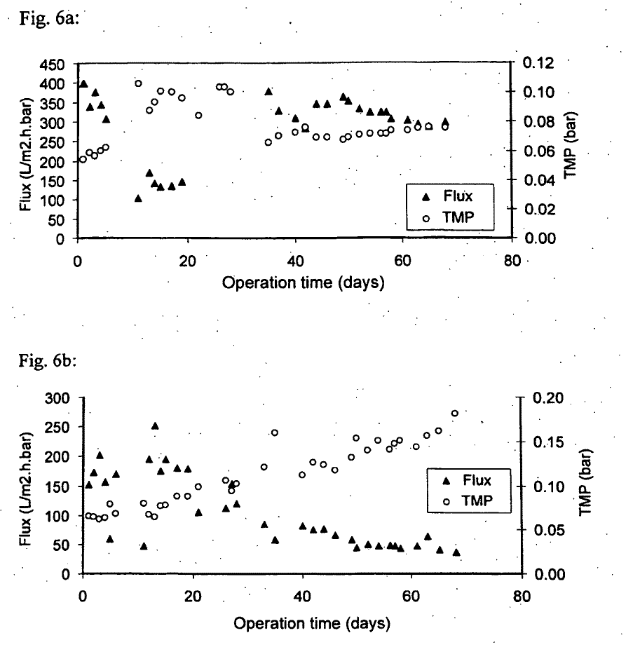

The water purification system of the present invention as illustrated in FIG. 1 shows the two separate membrane filter units 31a and 31b submerged in the closed bioreactor vessel 30. FIGS. 6a and 6b show the flux and trans-membrane pressure respectively of the two membrane filter units 31a and 31b at steady state conditions during the 75-day duration of this study. Both membrane filter units 31a and 31b were operated under repeating cycles of a 5-minute filtration interval and a 30-second backwash interval. Since the water purification system was a “closed” system, the trans-membrane pressure was not only affected by fouling and cake formation within the bioreactor vessel 30, but also by flow conditions and headspace pressure within the bioreactor vessel 30. FIGS. 6a and 6b show that the flux and trans-membrane pressures in the membrane filter units 31a and 31b were not the same during the course of the study. The first membrane filter unit 31a started with higher flux values and magnitudes of flux increases, and gradually reached a steady condition after about 5 weeks of continual operation (FIG. 6a). The second membrane filter unit 31b started with relatively steady flux and flux values decreased over time (FIG. 6b). These results were not expected since the first membrane filter unit 31a operated under higher flux conditions and was therefore subjected to greater fouling pressures. However, the data collected can be explained as a consequence of flow rates. The initial increase in the flux of the first membrane filter unit 31a was due to a chemical pre-cleaning treatment prior to the start of the study. It was experimentally found that chemically cleaned membranes show more resistance at the start up and gradually achieve higher flux. This might be due to change in polarity of the membrane and biofilm formation on the membrane.

The constant trans-membrane pressure in the first membrane filter unit 31a (FIG. 6a) can be explained by the concept of critical flux. Critical flux is defined as a flux below which the membrane fouling does not occur. The critical flux is related to different factors such s hydrodynamics and scouring rate. The data in FIG. 6a suggest that the first membrane filter unit 31a operated under critical flux conditions thereby resulting a minimal fouling. The data in FIG. 6b indicate that the second membrane filter unit 31b operated under lower flux conditions in comparison to the first membrane filter unit 31a and therefore, the second membrane filter unit 31b was subjected to greater fouling pressures. This fouling was found to be the consequence lower rates scouring supplied to the second membrane filter unit 31b. Subsequent measurements confirmed that the nitrogen (headspace) scouring rate of the first membrane filter unit 31a was 18 L min⁻¹ as compared to a scouring rate of 12 L min⁻¹ for the second membrane filter unit 31b thereby showing the impact of membrane scouring processes on membrane operation and fouling.

### Example 3

The preferred embodiment of the present invention illustrated in FIG. 1 was used to assess denitrification of a final effluent containing high nitrate levels produced by a municipal water treatment facility located in Winnipeg, Manitoba, Canada. The storage tank 10 and the bioreactor vessel 30 were filled with the municipal final effluent, while the gas-saturation mixing tank 16 was filled with hydrogen gas from gas cylinder 13 until the pressure inside the gas saturation tank 16 was 120 psi. The municipal final effluent transferred into the bioreactor vessel 30 was then inoculated with wastewater-activated sludge containing hydrogenotrophic denitrifying bacteria. The wastewater-activated sludge was obtained from the same municipal water treatment facility. The working pressure of the outflow pressure regulator valve 19 interconnected to the liquid outflow line 18 was adjusted to 125 psi, thereby maintaining pressure within the gas saturation mixing chamber at 125 psi. Municipal final effluent was then pumped from storage tank 10 into the gas saturation mixing tank 16 wherein it was mixed by agitator 17. After the municipal final effluent was supersaturated with hydrogen gas as determined by the head space method described in Example 2, it was then released from the gas saturation mixing tank 16 through the saturated feed outflow line 18 by the outflow pressure regulator valve 19 into the bioreactor vessel 30 wherein the supersaturated municipal final effluent was commingled and mixed with the unsaturated municipal final effluent which had been previously inoculated with wastewater-activated sludge. Concurrent with the introduction of the supersaturated municipal final effluent into the bioreactor vessel 30, the flow rate of municipal final effluent from the storage tank 10 into the bioreactor vessel 30 was set at 17 mL min⁻¹ while the flow rate of municipal final effluent from the storage tank 10 into the gas-saturation mixing tank 16 was set at 16 mL min⁻¹ and maintained at this rate for the duration of the study. A constant volume of municipal final effluent was maintained into bioreactor vessel by the float valve 38 which regulated the flow of municipal final effluent from the storage tank 10. The delivery of high concentrations of hydrogen and nitrate into the bioreactor vessel 10 stimulated metabolism and proliferation by the hydrogenotrophic denitrifying bacteria thereby converting nitrate into nitrogen gas which accumulated in the headspace of the bioreactor vessel 30 from where it was periodically recycled through gas recirculation line 32 into the hollow-fibre membrane filter units 31a and 31b by gas recirculation pump 33. The recycled nitrogen gas was forced from the interior to the exterior of the hollow-fibre membrane filter units 31a and 31b thereby: (a) scouring from the outer surfaces of the filters any biofilms that may have been formed there by the hydrogenotrophic denitrifying bacteria, and (b) facilitating the mixing and turbulence of the municipal final effluent contained within the bioreactor vessel 30. When the headspace gases were not being recycled through the membrane filter units 31a and 31b, denitrified water diffused from the bioreactor vessel 30 through the membrane filter units 31a and 31b thereby separating the denitrifying bacteria from the treated water which is also referred to as permeate. The permeate was removed from the bioreactor vessel 30 through permeate outflow lines 36a and 36b by permeate pumps 37a and 37b into a permeate holding tank 39 and then released through effluent outflow line 40. The venting of excess nitrogen gas formed in the headspace of the bioreactor vessel 30 was controlled through pressure relief line 34 by pressure regulator valve 35. The two membrane filter units 31a and 31b were operated under repeating cycles of a 5-minute filtration interval and a 30-second backwash interval. The bioreactor unit 6 was operated at room temperature (25-28° C.) with an SRT of 20 days and HRT of 3 hours. Both influent and effluent were sampled and analyzed for nitrate, nitrite, total and soluble chemical oxygen demand, pH, alkalinity, true colour, turbidity, hardness, total dissolved solids and total coliforms. The mixed liquor from the reactor was analyzed for volatile and total suspended solids and soluble COD. These analyses were performed according to Standard Methods (APHA, 1998). The dissolved hydrogen in the permeate tank was monitored using an Orbisphere online dissolved hydrogen analyzer.

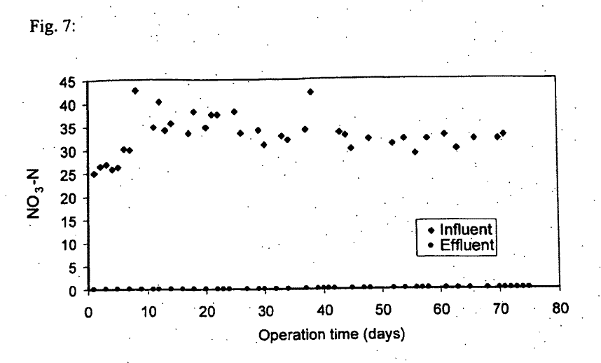

FIG. 7 shows that the water purification treatment system of the present . invention was effective in complete removal of nitrates from the municipal final effluent. The municipal final effluent coming from the storage tank 10 contained 33±4 mg L⁻¹ NO₃—N with a loading rate of 0.14 kg N m⁻³ d⁻¹. However, NO₃—N was not detected in the effluent samples collected from the permeate holding tank 39 throughout the 75-day duration of the study. Furthermore, no nitrite accumulation was observed. The dissolved hydrogen concentration in the effluent ranged between 0.03 to 0.1 mg L⁻¹.

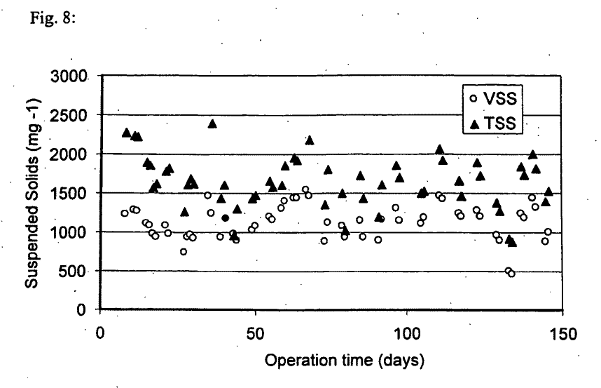

FIG. 8 shows the concentrations of volatile suspended solids (VSS) and total suspended solids (TSS) measured during the 75-day duration of the study. The average value for the VSS component was 1127±235 mg L⁻¹ and the average value for the TSS component was 1645±327 mg L⁻¹.

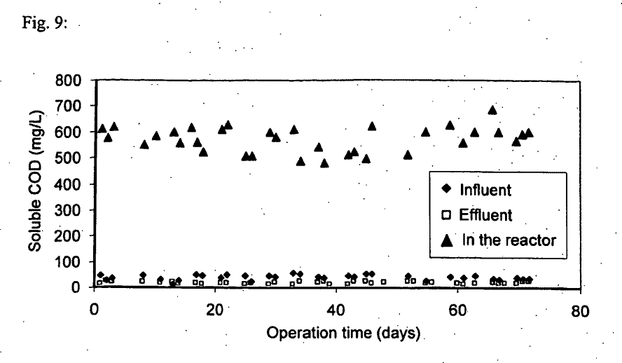

FIG. 9 shows that the organic carbon content of the effluent (17±4 mg L⁻¹ as COD) was consistently lower than that of the influent feed. The organic carbon removal was mostly achieved by membrane rejection. The organic carbon which passed through the membrane filter units, could either originate from the incoming feed or from SMP produced during denitrification.

Table 1 shows the effects of the water purification system of the present invention on various parameters used to assess water quality. Soluble and total organic carbon levels, dissolved organic carbon, turbidity, hardness and total dissolved solids were substantially reduced while nitrates and coliform bacteria were non-detectable in effluent samples collected from the permeate holding tank 39.

TABLE 1

| | Measurement | | |
|---|---|---|---|
| Parameters | unit | Influent | Effluent |
| Soluble COD | mg L⁻¹ | 39 ± 9 | 17 ± 4 |
| Total COD | mg L⁻¹ | 62 ± 14 | 17 ± 4 |
| Dissolved organic Carbon | mg L⁻¹ | 16.5 ± 3 | 9 ± 0.3 |
| Dissolved Hydrogen | mg L⁻¹ | 0 | 0.1 ± 0.03 |
| Nitrate | mg N L−1 | 33 ± 4 | 0 |
| Alkalinity | mg CaCO₃ L⁻¹ | 237 ± 37 | 308 ± 48 |
| pH | — | 7.8 ± 0.4 | 9.3 ± 0.14 |
| Turbidity | Ntu | 20 ± 5 | 0.16 ± 0.09 |
| True Color | Hu | 30 | 25 ± 5 |
| Hardness | mg L⁻¹ | 324 ± 65 | 170 ± 10 |
| Total Dissolved Solids | mg L⁻¹ | 580 ± 100 | 76 ± 20 |
| Total Coliform | CFU/100 ml | 2 × 10⁶ | ND |

While a particular exemplary embodiment of the present invention has been described in the foregoing, it is to be understood that other embodiments are possible within the scope of the present invention and are intended to be included herein. In view of numerous changes and variations that will be apparent to persons skilled in the art, the scope of the present invention is to be considered limited solely by the appended claims.

1. An apparatus for saturating a liquid with a gas and delivery of the gas-saturated liquid to a biological system, comprising:
a gas-saturation unit having a sealable vessel for holding a gas and a liquid under pressure, a liquid feed for introducing a liquid into the vessel, a gas feed for introducing a gas into the vessel, a gas-saturated liquid outflow for liquid saturated with said gas, and a pressure regulator valve operatively associated with said liquid outflow;
a closed-system bioreactor unit for containing a system for a biological process therein, said closed-system bioreactor unit being connected to said gas-saturation unit via said gas-saturated liquid outflow downstream of said valve;
a physical support provided within said closed-system bioreactor unit for the development thereon of a biofilm for the biological process contained therein; and
a controller for regulating release of said gas-saturated liquid from the gas-saturation unit into the closed-system bioreactor unit.

2. An apparatus according to claim 1 wherein the gas-saturation unit is provided with a controllable liquid feed pump in communication with said controller and a controllable gas valve in communication with said controller for cooperatingly creating a pressure therein the sealable vessel.

3. An apparatus according to claim 1 wherein the gas-saturation unit is provided at least one pressure sensor and at least one dissolved gas sensor, said sensors configured for communicating with said controller.

4. An apparatus according to claim 1 wherein the closed-system bioreactor unit is provided at least one pressure sensor and at least one dissolved gas sensor, said sensors configured for communicating with said controller.

5. An apparatus according to claim 1 wherein the controller is configured to concurrently communicate with the gas-saturation unit and the closed-system bioreactor unit while said controller is regulating the release of gas-saturated liquid from the gas-saturation unit into the closed-system bioreactor unit.

6. (canceled)

7. An apparatus according to claim 1 wherein the closed-system bioreactor is selected from the group consisting of continuous stirred-tank reactors, continuous flow stirred-tank reactors, plug-flow reactors, fluidized-bed reactors, said reactors equipped with external re-circulating lines having pumps interconnected therein.

8. (canceled)

9. An apparatus according Co claim 1 wherein the physical support is a membrane filter unit.

10. An apparatus according to claim 9 where in the membrane filter unit is a hollow-fibre membrane filter unit.

11. An apparatus according to claim 1 wherein the biological process is a denitrification of a nitrate-containing water supply.

12. An apparatus according to claim 11 wherein the denitrification biological process is a hydrogenotrophic denitrification biological process.

13. An apparatus according to claim 1 wherein the gas supply is a hydrogen supply.

14. A method for affecting a biological process within a bioreactor, the method comprising:
saturating a selected liquid with a selected gas by a pressure applied within a closed-system gas-saturation unit thereby producing a gas-saturated liquid; and
controllably delivering the gas-saturated liquid to a closed-system bioreactor receiving a liquid supply therein, the closed-system bioreactor provided with a physical support configured for supporting a biological process thereon.

15. A method according to claim 14 wherein the unsaturated liquid is drawn from the liquid supply to the closed-system bioreactor.

16. A method according to claim 14 wherein the rate of release of gas-saturated liquid from the gas-saturation unit to the closed-system bioreactor unit is limited to a rate equal to or less than the rate of consumption of the gas by the biological process occurring within the liquid supply contained within the closed-system bioreactor unit.

17. A method according to claim 16 wherein the rate of gas consumption by the biological process occurring within the liquid supply is calculable from repeated measurements of the dissolved gas concentration in said liquid supply contained within the closed-system bioreactor unit.

18. A method according to claim 17 wherein the rate of release of gas-saturated liquid from the gas-saturation unit to the bioreactor unit is equal to or less than the calculated rate of gas consumption by the biological process occurring within said liquid supply contained within the closed-system bioreactor unit.

19. A method according to claim 14 wherein the biological process is a denitrification process.

20. A method according to claim 14 wherein the biological denitrification process is a hydrogentrophic denitrification process.

21. A method according to claim 14 wherein the gas is hydrogen gas.

22. A method for denitrification of a nitrate-containing water supply, the method comprising:
saturating a liquid with a gas by a pressure applied in a closed-system gas-saturation unit thereby producing a gas-saturated liquid; and
controllably delivering the gas-saturated liquid to a bioreactor receiving a supply of nitrate-containing water and containing a biological denitrification process therein.

23. An apparatus for saturating a liquid with a gas whereafter the gas-saturated liquid is delivered to a liquid system thereby affecting a biological process occurring within the liquid system, the apparatus comprising:
a closed-system gas-saturation unit comprising a sealable vessel for saturating a selected liquid contained therein with a selected gas thereby producing a gas-saturated liquid, a liquid feed supply line having a controllable pump interconnected therein for controllably pumping the liquid into the vessel, a gas supply having a valve interconnected therein for controllably delivering the gas into the vessel, and a gas-saturated liquid outflow line having a pressure regulator valve interconnected therein;
a reactor unit for containing a liquid system therein and for controllably releasing liquid therefrom, the reactor unit connected to the gas-saturated liquid outflow line of the closed-system gas-saturation unit and communicating therewith the regulator valve; and
a controller for regulating release of said gas-saturated liquid from the gas-saturation unit into the reactor unit.

24. A method according to claim 14 wherein the physical support is a membrane filter unit.

25. A method according to claim 24 wherein the physical support is a hollow-fibre membrane filter unit.
